(19) United States
(12) Patent Application Publication
(10) Pub. No.: US 2012/0262548 A1
(43) Pub. Date: Oct. 18, 2012

(54) METHOD OF GENERATING THREE-DIMENSIONAL IMAGE AND ENDOSCOPIC APPARATUS USING THE SAME

(76) Inventors: Wonhee Choe, Seoul (KR); Jae-guyn Lim, Seongnam-si (KR); Seong-deok Lee, Seongnam-si (KR)

(21) Appl. No.: 13/275,063

(22) Filed: Oct. 17, 2011

(30) Foreign Application Priority Data
Apr. 14, 2011 (KR) 10-2011-0034752

(51) Int. Cl. H04N 13/02

(52) U.S. Cl. 348/45; 348/E13.074

(57) ABSTRACT

An endoscopic apparatus is provided. The endoscopic apparatus includes a light projection unit for configured to selectively projecting patterned light onto a body part, an imaging unit configured to capturing an image of the body part on which shadows corresponding to the predefined portions are formed due to the patterned light, and an image processing unit configured to generate an image showing depth information of the body part based on sizes of the shadows formed on the body part. Certain predefined portions of an emission surface of the patterned light may be blocked in a pattern.

### CROSS-REFERENCE TO RELATED APPLICATION(S)

This application claims the benefit under 35 U.S.C. §119(a) of Korean Patent Application No. 10-2011-0034752, filed on Apr. 14, 2011, in the Korean Intellectual Property Office, the entire disclosure of which is incorporated herein by reference for all purposes.

### BACKGROUND

1. Field

The following description relates to a method of generating a three-dimensional (3D) image and an endoscopic apparatus using the same.

2. Description of the Related Art

Endoscopes are medical apparatuses that are capable of observing lesions of organs while being inserted into a body. An endoscope may be used without making an incision in the body, and as a result has become widely used. In addition to black-and-white images, an endoscopic may provide high-resolution color images and narrow-band images due to development of image processing technologies.

As the imaging ability of endoscopes increase, lesions may more accurately be detected. A representative example of a next-generation endoscope is a 3D endoscope. Generally, an endoscope is able to capture only two-dimensional (2D) images, and thus, may not accurately detect lesions. For example, if a lesion has a similar color as neighboring tissues but protrudes at a different height than the neighboring tissues, the lesion may not be easily detected by viewing a 2D image.

### SUMMARY

According to an aspect, an endoscopic apparatus is provided. The endoscopic apparatus includes a light projection unit configured to selectively project patterned light onto a body part, an imaging unit configured to capture an image of the body part on which shadows corresponding to the predefined portions are formed due to the patterned light, and an image processing unit configured to generate an image comprising depth information of the body part based on sizes of the shadows that are formed on the body part. Predefined portions of an emission surface of the patterned light are blocked in a pattern.

The image processing unit may include a depth calculation unit configured to calculate depths of the shadows formed on the body part, based on the sizes of the shadows, and an image generation unit configured to generate the image comprising the depth information of the body part based on the calculated depths of the shadows.

The image generation unit may be further configured to determine depths of corresponding regions where the shadows are formed, based on the sizes of the shadows, and generate the image of the body part to which the depths of the corresponding regions are applied.

In response to a difference in depth between a first shadow and a second shadow adjacent to the first shadow from among the shadows formed on the body part being outside of a predefined range, the image generation unit may be configured to display the difference in depth on a corresponding region of the image in which the first shadow is formed.

The image processing unit may further include a target region setting unit configured to set a target region required for depth measurement on the body part, a depth calculation unit configured to calculate depths of the body part and the target region based on an average value of the sizes of the shadows formed on the body part and an average value of the sizes of the shadows formed on the target region, respectively, and an image generation unit configured to display a difference in depth between the target region and the body part on the image of the body part.

The endoscopic apparatus may further include a lookup table configured to store depths corresponding to various sizes of the shadows. The depth calculation unit may be further configured to calculate the depths of the shadows by reading from the lookup table the depths of the shadows corresponding to the sizes of the shadows formed on the body part.

The image processing unit may include an error range determination unit configured to calculate a depth of the body part based on an average value of the sizes of the shadows formed on the body part, and to determine an error range of the depth information based on a resolution of the image of the body part and the calculated depth of the body part.

The light projection unit may include an image generation unit configured to generate light, and an optical filter configured to generate patterned light by blocking in predefined portions the light generated by the image generation unit.

The optical filter may be configured to switchably block or transmit light in predefined portions.

The optical filter may be configured to block light of infrared wavelength ranges in predefined portions.

In another aspect, a method of generating a three-dimensional (3D) image is provided. The method includes receiving an image of a body part captured by projecting patterned light onto the body part, calculating depths of shadows formed on the body part in correspondence with to the predefined portions, based on the sizes of the shadows, and generating an image showing depth information of the body part based on the calculated depths of the shadows.

The generating of the image may include determining depths of corresponding regions where the shadows are formed, based on the sizes of the shadows, and generating the image of the body part to which the depths of the corresponding regions are applied.

In response to a difference in depth between a first shadow and a second shadow adjacent to the first shadow from among the shadows formed on the body part being out of a predefined range, the generating of the image may include displaying the difference in depth on a corresponding region of the image in which the first shadow is formed.

The method may further include setting a target region for depth measurement on the body part, calculating an average value of the depths of the shadows formed on the body part and an average value of the depths of the shadows formed on the target region, and calculating a difference between the average values. The generating of the image may include displaying the difference on the image of the body part.

The calculating of the depths is performed using a lookup table that stores depths corresponding to various sizes of the shadows.

The method may further include calculating a depth of the body part by averaging of the depths of the shadows formed on the body part, and determining an error range of the depth information using a resolution of the image of the body part and the calculated depth of the body part.

In another aspect, there is provided a computer-readable storage having stored therein program instructions to cause a processor to implement a method of generating a three-dimensional (3D) image, the method including receiving an image of a body part captured by projecting patterned light onto the body part, wherein predefined portions of an emission surface of the patterned light are blocked in a pattern, calculating depths of shadows formed on the body part in correspondence with to the predefined portions, based on the sizes of the shadows, and generating an image showing depth information of the body part based on the calculated depths of the shadows.

Other features and aspects may be apparent from the following detailed description, the drawings, and the claims.

### BRIEF DESCRIPTION OF THE DRAWINGS

FIG. 1 is a diagram illustrating an example of an endoscopic apparatus;

FIG. 2 is a diagram illustrating an example of an image processing unit illustrated in FIG. 1;

FIG. 3 is an example of an image of a body part on which shadows are formed in a pattern;

FIGS. 4 and 5 are examples of images showing a body part onto which patterned light is projected, a target region, and shadows formed on the body part;

FIG. 6A is a diagram illustrating an example of a light projection unit illustrated in FIG. 1;

FIG. 6B is a diagram illustrating an example of an optical filter illustrated in FIG. 6A;

FIG. 7 is a diagram illustrating an example of shadows formed in a pattern due to light transmitted through the optical filter illustrated in FIG. 6A;

FIGS. 8 through 10 are flowcharts illustrating examples of methods of generating a 3D image.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

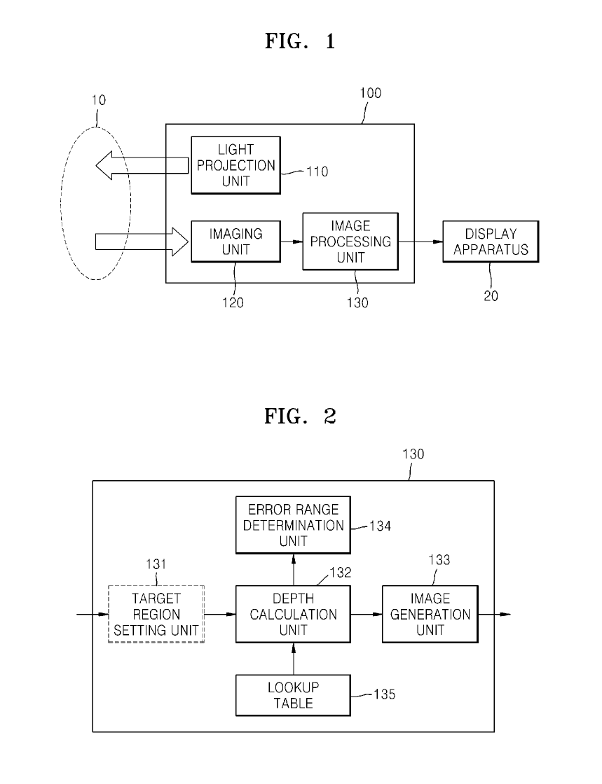

FIG. 1 illustrates an example of an endoscopic apparatus 100. Referring to FIG. 1, the endoscopic apparatus 100 includes a light projection unit 110, an imaging unit 120, and an image processing unit 130.

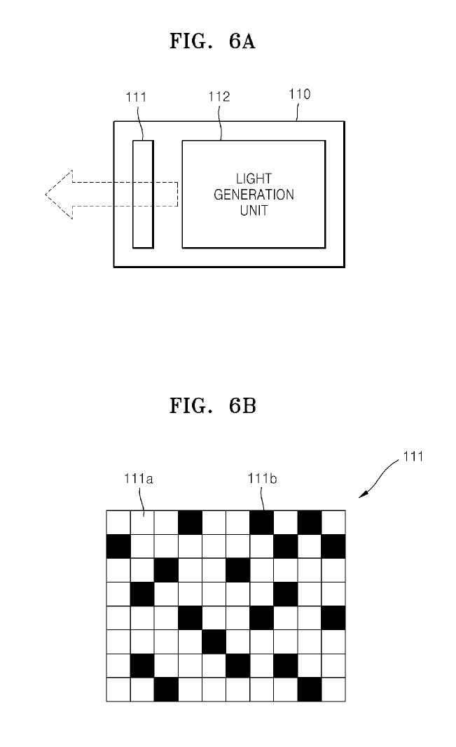

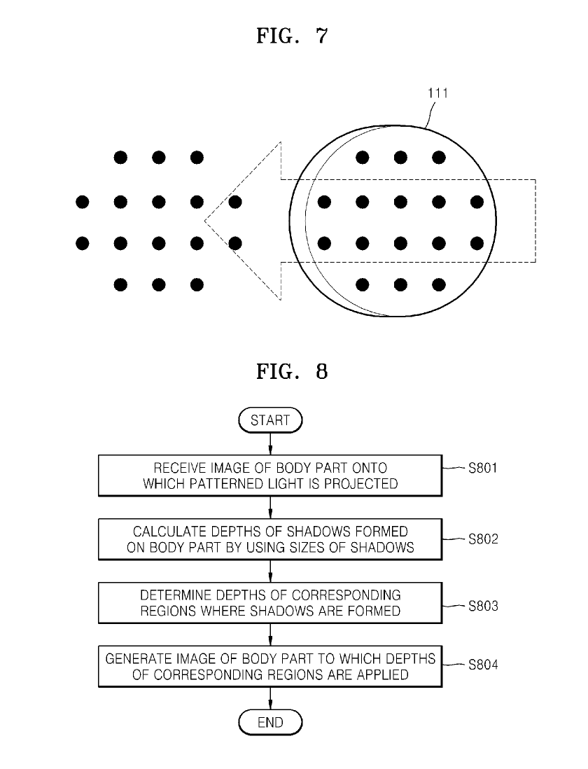

The light projection unit 110 may be used to project light onto a body part 10. As an example, the light projection unit 110 may project normal light or patterned light. An example of a structure of the light projection unit 110 is described with reference to FIGS. 6 and 7. Normal light may refer to light projected from a normal light source in order to illuminate a body part, and patterned light may refer to light of that has portions that are blocked to form a pattern so as to form shadows according to the pattern when projected onto a certain target. Hereinafter, is an example of the light projection unit 110 projecting patterned light in order to obtain depth information of the body part 10.

The imaging unit 120 may transform an image of the body part 10 on which the patterned light is projected by the light projection unit 110 into an electrical image signal. In the current example, because depth information is calculated using the sizes of shadows formed in a pattern on a captured image, the resolution of the image captured by the imaging unit 120 may have the same accuracy or approximately the same accuracy as the depth information provided by the endoscopic apparatus 100. For example, the accuracy may relate to an error range. Accordingly, by capturing a high resolution image with the imaging unit 120, more accurate depth information may be obtained.

The image processing unit 130 may receive and analyze the electrical signal related to the image of the body part 10. The received electrical signal may be output by the imaging unit 120. The image processing unit 130 may calculate the depth information of the body part 10. Shadows are formed in a certain pattern by projecting the patterned light are on the body part 10. By analyzing the sizes of the shadows, a depth of a region on the body part 10 and a depth of the body part 10 may be calculated. An example of the operation of the image processing unit 130 is described with reference to FIG. 2. The image processing unit 130 may process and output the received image signal to a display apparatus 20. The display apparatus 20 may receive the image signal from the image processing unit 130 and output an image.

As one example, the display apparatus 20 is illustrated as a separate apparatus that is disposed outside the endoscopic apparatus 100 in FIG. 1. As another example, the display apparatus 20 may be included in the endoscopic apparatus 100.

FIG. 2 illustrates an example of the image processing unit 130 illustrated in FIG. 1. Referring to FIG. 2, the image processing unit 130 includes a target region setting unit 131, a depth calculation unit 132, an image generation unit 133, an error range determination unit 134, and a lookup table 135.

The target region setting unit 131 may set a target region for depth measurement on the body part 10. The target region may be set by a user or may be set as a region of the body part 10. The target region setting unit 131 is optional in the image processing unit 130 and may be omitted. The target region setting unit 131 may be used to increases the calculation efficiency of calculating depths, or to calculates an average depth of the target region.

The depth calculation unit 132 may calculate a depth of the body part 10. Depths of shadows formed in a pattern on the body part 10 may be calculated using sizes of the shadows. In response to the target region setting unit 131 setting only a partial region of the body part 10 as the target region, a depth of the target region may be calculated. For example, the depth of the target region may be calculated by calculating the depths of the shadows and then averaging the depths of the shadows formed on the target region based on the sizes of the shadows. As another example, the depths of the target region may be calculated by averaging the sizes of the shadows formed on the target region and then calculating a depth corresponding to the average size. In this case, although a certain calculation method may be performed whenever a depth of each shadow is calculated using a size of the shadow, in order to improve efficiency, such as faster calculations and reduced number of calculations for calculating depths, the depths may be calculated using the lookup table 135 that stores distance values. The distance values may correspond to shadow sizes.

The image generation unit 133 may generate an image showing depth information output from the depth calculation unit 132 on the image of the body part 10. Accordingly, the depths of the shadows may be calculated by the depth calculation unit 132. Because the depths of the shadows formed on the body part 10 correspond to the depths of corresponding regions where the shadows are formed on the body part 10, an image showing the depths of the shadows on the image of the body part 10 may be generated.

Various methods may be used to generate the image showing the depth information of the body part 10. As one example, a stereoscopic image of the body part 10 may be generated. As another example, a depth value of a specific region on the body part 10 may be displayed on a corresponding region in the image of the body part 10. A method of generating a stereoscopic image by using depth information of a two-dimensional (2D) image is understood in the field of three-dimensional (3D) image processing. Thus, a description thereof is omitted for conciseness.

A method of displaying a depth value on the image of the body part 10 is described.

A method of displaying a depth value of a region that may have a lesion on the image of the body part 10 is described. Depths of shadows formed in a pattern on the body part 10 due to patterned light may be calculated based on the sizes of the shadows. In this case, although a calculation method may be performed each time a depth of each shadow is calculated using a size of the shadow, in order to reduce time and calculations, the depths may be determined using the lookup table 135 that stores distance values corresponding to shadow sizes. After the depths of all of the shadows formed on the body part 10 are calculated, any one shadow may be selected and a difference in depth between the selected shadow and a neighboring shadow may be calculated. In response to the difference in depth being outside a certain range the difference in depth may be displayed on a region corresponding to the selected shadow in the image of the body part 10. For example, a large difference in depth may indicate a high probability of a lesion. By performing the above process on at least one shadow formed on the body part 10, a region having a high likelihood of a may be analyzed on the image of the body part 10. As an example, the difference in depth may be displayed as a number on a corresponding region. As another example, the difference in depth may be displayed as an easily-recognizable color on a corresponding region.

An example of a method of displaying a depth value of a target region corresponding to a depth measurement on the image of the body part 10 is as described. In this example, a target region to be depth measured is identified on the body part 10. Depths of shadows formed in a pattern on the body part 10 due to patterned light are calculated using the sizes of the shadows. An average value of the depths of the shadows formed on the body part 10 is calculated, and an average value of the depths of the shadows formed on the target region is calculated. The calculated average value of the depths of the shadows formed on the body part 10 and the average value of the depths of the shadows formed on the target region respectively correspond to an average depth of the body part 10 and an average depth of the target region. In addition, the average depths of the body part 10 and the target region may also be calculated using an average value of the sizes of the shadows formed on the body part 10 and an average value of the sizes of the shadows formed on the target region. In this case, in order to improve calculation efficiency, the depths may be calculated using the lookup table 135 that stores distance values corresponding to shadow sizes. After the average depths of the body part 10 and the target region are calculated, a depth of the target region with respect to the body part 10 may be calculated by taking the difference of the average depth of the body part 10 from the average depth of the target region. This difference may be displayed on the target region in the image of the body part 10. The target region may be set by a user or may be automatically set. As such, a depth value of a specific region for depth measurement may be calculated more efficiently.

The error range determination unit 134 may determine an error range of depth information provided by the endoscopic apparatus 100. The error range determination unit 134 may determine the error range based on the average depth of the body part 10 calculated by the depth calculation unit 132 and a resolution of the image signal output from the imaging unit 120. For example, in response to the average depth of the body part 10 being large and the resolution of the image signal being low, the error range of the depth information may be large. A formula for determining the error range, is understood and thus, a description thereof is omitted for conciseness.

Due to the structure of the image processing unit 130, depth information of the body part 10 onto which patterned light is projected may be obtained. Hereinafter, a method of obtaining the depth information of the body part 10 onto which patterned light is projected is described with reference to the drawings.

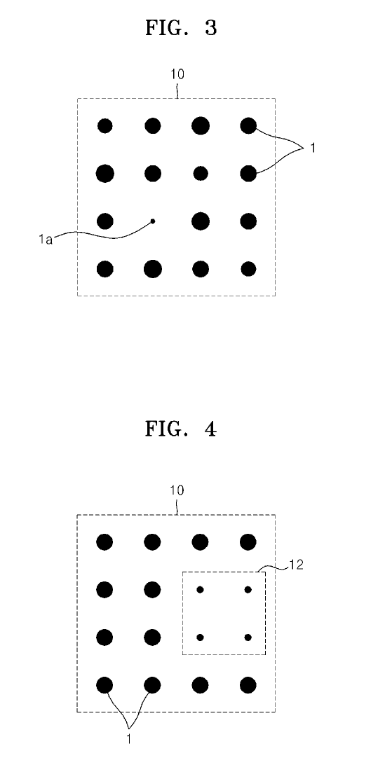

FIG. 3 is an example of an image of the body part 10 on which shadows 1 are formed in a pattern. Referring to FIG. 3, the shadows 1 are formed in a pattern on the body part 10. A size of each of the shadows 1 is determined according to a depth of a corresponding region. As a result, the shadows 1 may have different sizes. Correlations between a depth and a size of a shadow are to be described. The light projection unit 110 illustrated in FIG. 1 may generate patterned light using a light generation unit for generating light radiating from a certain spot. An optical filter may be disposed in front of the light generation unit. In this example, the size of the shadow may be increased if the depth is increased. If the light projection unit 110 generates patterned light proceeding in parallel from every spot, the size of the shadow may be constant regardless of the depth. In this case, due to perspective, the size of the shadow on a captured image is reduced if the depth is increased. Hereinafter, a case in which the light projection unit 110 generates radiating patterned light, for example, a case in which the size of the shadow is increased if the depth is increased, is assumed. As illustrated in FIG. 3, the shadows 1 formed on the body part 10 have sizes corresponding to their depths. Accordingly, the depths of the shadows 1 may be calculated by using the sizes of the shadows 1. In FIG. 3, most of the shadows 1 except for a shadow 1a have similar sizes. Accordingly, a region corresponding with the specific shadow 1a is identified as a region uniquely protruding upwards in comparison to neighboring regions, and thus, the region corresponding with the specific shadow 1a is determined as a region likely to have a lesion.

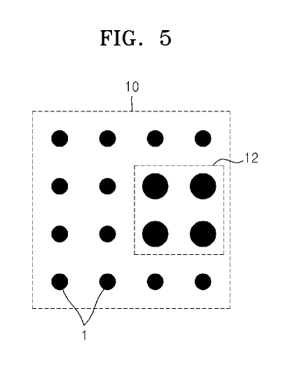

FIGS. 4 and 5 illustrate examples of images showing the body part 10 onto which patterned light is projected. In these examples, a target region 12, and the shadows 1 are formed on the body part 10. In FIGS. 4 and 5, for conciseness, the shadows 1 formed on the target region 12 have the same size, the shadows 1 formed on the body part 10 excluding the target region 12 have the same size, and the shadows 1 formed on the target region 12 are different in size from the size of the shadows 1 formed on the body part 10 excluding the target region 12.

Referring to FIG. 4, the size of the shadows 1 formed on the target region 12 is less than the size of the shadows 1 formed on the body part 10 other than the target region 12. That is, the target region 12 is a region protruding upwards in comparison to neighboring regions on the body part 10. An example of a method of calculating an approximate value of a depth of the target region 12 with respect to the body part 10 is described corresponding to FIG. 2.

Referring to FIG. 5, unlike FIG. 4, the size of the shadows 1 formed on the target region 12 are greater in size than the size of the shadows 1 formed on the body part 10 excluding the target region 12, and thus, the target region 12 is a region recessed downwards.

FIG. 6A illustrates an example of the light projection unit 110 illustrated in FIG. 1. Referring to FIG. 6A, the light projection unit 110 includes an optical filter 111 and a light generation unit 112. The light generation unit 112 generates light for illumination. The light generated by the light generation unit 112 may pass through the optical filter 111 and become normal light or patterned light. The optical filter 111 may completely transmit or partially block the light that passes through the optical filter 111. For example, in response to the light being partially blocked in some regions, the light that passes through the optical filter 111 may become normal light or patterned light. Also, patterned light may be generated by selectively blocking only light of some wavelength ranges. The selectively blocking may be configured for only some regions.

FIG. 6B illustrates an example of the optical filter 111 illustrated in FIG. 6A. Referring to FIG. 6B, the optical filter 111 includes transmissive regions 111a for transmitting light, and blocking regions 111b for blocking light. The blocking regions 111b are shown as block regions in FIG. 6B. For example, if the optical filter 111 is a lattice-type liquid crystal filter for switchably blocking or transmitting light in arbitrary certain regions of the liquid crystal filter, the blocking regions 111b may be formed to block light of all wavelength ranges or only light of infrared wavelength ranges. Accordingly, an image may be captured and depth information may be extracted from patterned light due to the blocking regions 111b, by adjusting the blocking regions 111b of the liquid crystal filter. In response to the blocking regions 111b being fixed on the optical filter 111, the optical filter 111 may be an infrared blocking filter for blocking light of only infrared wavelength ranges. Accordingly, capturing an image and extracting depth information may be performed at substantially the same time.

FIG. 7 illustrates an example of shadows formed in a pattern due to light transmitted through the optical filter 111 illustrated in FIG. 6A.

Referring to FIG. 7, regularly repeating circles formed in a pattern on the optical filter 111 are regions for blocking light. By transmitting normal light through the optical filter 111 in which blocking regions are formed in a certain pattern, patterned light illustrated in FIG. 7 is obtained. Although not shown in FIG. 7, the blocking regions in the optical filter 111 may be formed in other patterns, or the blocking regions may not be formed at all. In this example, the operation of the optical filter 111 may be controlled and light transmitted through the optical filter 111 may become normal light or patterned light having an arbitrary pattern. In order to selectively block light, a liquid crystal filter may be used as the optical filter 111. If a liquid crystal filter is used as the optical filter 111, some of a plurality of pixels on the optical filter 111 may block light and some of the pixels may transmit light by applying a signal for controlling operation of the optical filter 111 to the optical filter 111. The signal may be a current signal or a voltage signal.

FIGS. 8 through 10 illustrate examples of methods of generating a 3D image.

Referring to FIG. 8, an image of a body part on which shadows are formed in a pattern due to projected patterned light is received, in S801. The receiving of the image may refer to receiving of an electrical image signal transformed from a captured image. In response to the image of the body part 10 being received, the shadows formed on the body part may be analyzed. In S802, depths of the shadows formed on the body part are calculated using the sizes of the shadows.

In this example, in order to more efficiently calculate depths, the depths may be calculated using a lookup table that stores distance values corresponding to shadow sizes. After the depths of the shadows are calculated, depths of corresponding regions in which the shadows are formed may be determined, in S803. An image of the body part to which the depths of the corresponding regions are applied is generated, in S804, thereby terminating a process. In this case, an example of the image of the body part to which the depths of the corresponding regions are applied is a stereoscopic image to which depth information is reflected. As another example, a depth may be displayed as a number on the image of the body part.

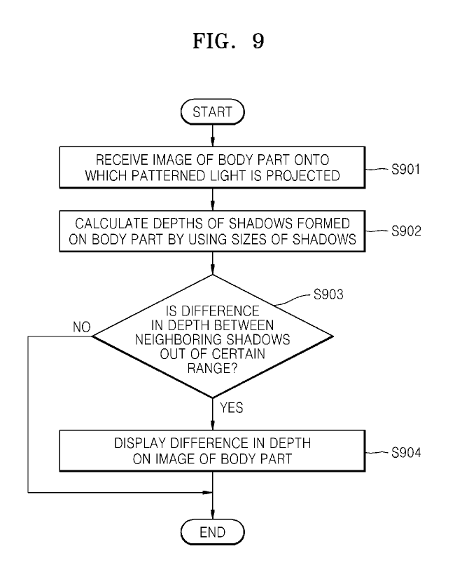

Referring to FIG. 9, an image of the body part onto which patterned light is projected is received, in S901, and depths of shadows formed on the body part 10 are calculated using the sizes of the shadows in S902. In this example, S901 and S902 respectively correspond to S801 and S802 illustrated in FIG. 8, and thus, a description thereof is omitted for conciseness. After the depths of the shadows formed on the body part are calculated, a determination is made to determine whether a difference in depth between a shadow and a neighboring shadow is out of a certain range, in S903. For example, a shadow may be selected from among all of the shadows formed on the body part and a difference in depth between the selected shadow and a neighboring shadow may be calculated. The process may be performed on each shadow and a determination may be made as to whether the difference in depth is out of the certain range. In response to the difference in depth being out of the certain range, the method proceeds to S904 and the difference in depth is displayed on a region of a corresponding shadow in the image of the body part. For example, the difference in depth may be displayed as a number or a color.

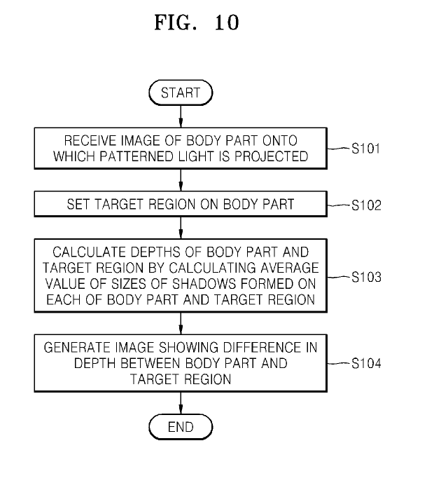

Referring to FIG. 10, an image of a body part onto which patterned light is projected is received, in S101. A target region for depth measurement is set on the body part, in S102. After the target region is set, depths of the body part and the target region are calculated based on an average value of sizes of shadows formed on the body part and an average value of sizes of shadows formed on the target region, in S103. As another example, depths of all shadows formed on the body part may be calculated, and the depths of the shadows formed on the body part and the depths of the shadows formed on the target region may be separately averaged. After the depths of the body part and the target region are calculated in S103, a depth of the target region with respect to the body part is displayed on the image of the body part, in S104. For example, a value of the depth of the target region may be obtained by subtracting the depth of the body part from the depth of the target region. In this case, the depth of the target region with respect to the body part may be calculated using the average depths of the body part and the target region, and the depth of the target region with respect to the body part may be an approximate value. The depth of the target region with respect to the body part may be displayed as a number or an arbitrary color on the target region in the image of the body part.

As described in various examples, depth information of a body part may be obtained using only patterned light without adding a separate configuration. Also, a lesion may be more easily detected by displaying depth information of a region that is likely to have a lesion on a captured image.

Examples of a medical device including the endoscopic apparatus includes upper gastrointestinal systems, surgical equipment, and the like.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An endoscopic apparatus comprising:
a light projection unit configured to selectively project patterned light onto a body part, wherein predefined portions of an emission surface of the patterned light are blocked in a pattern;
an imaging unit configured to capture an image of the body part on which shadows corresponding to the predefined portions are formed due to the patterned light; and
an image processing unit configured to generate an image comprising depth information of the body part based on sizes of the shadows that are formed on the body part.

2. The endoscopic apparatus of claim 1, wherein the image processing unit comprises:
a depth calculation unit configured to calculate depths of the shadows formed on the body part, based on the sizes of the shadows; and
an image generation unit configured to generate the image comprising the depth information of the body part based on the calculated depths of the shadows.

3. The endoscopic apparatus of claim 2, wherein the image generation unit is further configured to determine depths of corresponding regions where the shadows are formed, based on the sizes of the shadows, and to generate the image of the body part to which the depths of the corresponding regions are applied.

4. The endoscopic apparatus of claim 2, wherein, in response to a difference in depth between a first shadow and a second shadow adjacent to the first shadow from among the shadows formed on the body part being outside of a predefined range, the image generation unit is configured to display the difference in depth on a corresponding region of the image in which the first shadow is formed.

5. The endoscopic apparatus of claim 1, wherein the image processing unit further comprises:
a target region setting unit configured to set a target region for depth measurement on the body part;
a depth calculation unit configured to calculate depths of the body part and the target region based on an average value of the sizes of the shadows formed on the body part and an average value of the sizes of the shadows formed on the target region, respectively; and
an image generation unit configured to display a difference in depth between the target region and the body part on the image of the body part.

6. The endoscopic apparatus of claim 2, further comprising a lookup table configured to store depths corresponding to various sizes of the shadows,
wherein the depth calculation unit is further configured to calculate the depths of the shadows by reading, from the lookup table, the depths of the shadows corresponding to the sizes of the shadows formed on the body part.

7. The endoscopic apparatus of claim 1, wherein the image processing unit comprises an error range determination unit configured to calculate a depth of the body part based on an average value of the sizes of the shadows formed on the body part, and to determine an error range of the depth information based on a resolution of the image of the body part and the calculated depth of the body part.

8. The endoscopic apparatus of claim 1, wherein the light projection unit comprises:
an image generation unit configured to generate light; and
an optical filter configured to generate patterned light by blocking, in predefined portions, the light generated by the image generation unit.

9. The endoscopic apparatus of claim 8, wherein the optical filter is configured to switchably block or transmit light in predefined portions.

10. The endoscopic apparatus of claim 8, wherein the optical filter is configured to block light of infrared wavelength ranges in predefined portions.

11. A method of generating a three-dimensional (3D) image, the method comprising:
receiving an image of a body part captured by projecting patterned light onto the body part, wherein predefined portions of an emission surface of the patterned light are blocked in a pattern;
calculating depths of shadows formed on the body part in correspondence with to the predefined portions, based on the sizes of the shadows; and
generating an image showing depth information of the body part based on the calculated depths of the shadows.

12. The method of claim 11, wherein the generating of the image comprises:
determining depths of corresponding regions where the shadows are formed, based on the sizes of the shadows; and
generating the image of the body part to which the depths of the corresponding regions are applied.

13. The method of claim 11, wherein, in response to a difference in depth between a first shadow and a second shadow adjacent to the first shadow from among the shadows formed on the body part being out of a predefined range, the generating of the image comprises displaying the difference in depth on a corresponding region of the image in which the first shadow is formed.

14. The method of claim 11, further comprising:
setting a target region for depth measurement on the body part; and
calculating an average value of the depths of the shadows formed on the body part and an average value of the depths of the shadows formed on the target region, and calculating a difference between the average values,
wherein the generating of the image comprises displaying the difference on the image of the body part.

15. The method of claim 11, wherein the calculating of the depths is performed using a lookup table that stores depths corresponding to various sizes of the shadows.

16. The method of claim 11, further comprising:
calculating a depth of the body part by averaging of the depths of the shadows formed on the body part; and
determining an error range of the depth information using a resolution of the image of the body part and the calculated depth of the body part.

17. A computer-readable storage medium having stored therein program instructions to cause a processor to implement a method of generating a three-dimensional (3D) image, the method comprising:
receiving an image of a body part captured by projecting patterned light onto the body part, wherein predefined portions of an emission surface of the patterned light are blocked in a pattern;
calculating depths of shadows formed on the body part in correspondence with to the predefined portions, based on the sizes of the shadows; and
generating an image showing depth information of the body part based on the calculated depths of the shadows.
